(19) United States
(12) Patent Application Publication
(10) Pub. No.: US 2010/0262584 A1
(43) Pub. Date: Oct. 14, 2010

(54) Disinfecting a file system

(75) Inventors: Pavel Turbin, Helsinki (FI); Jarno Niemelä, Espoo (FI)

Correspondence Address: HARRINGTON & SMITH, 4 RESEARCH DRIVE, Suite 202, SHELTON, CT, 06484-6212, US

(73) Assignee: F-Secure Corporation

(21) Appl. No.: 12/798,231

(22) Filed: Mar. 30, 2010

(30) Foreign Application Priority Data
Apr. 8, 2009 (GB) 0906109.4

(51) Int. Cl. G06F 21/00; G06F 17/30

(52) U.S. Cl. 707/674; 726/24; 707/769; 707/E17.01

(57) ABSTRACT

A method and apparatus for disinfecting an infected electronic file in a file system. A file system is scanned using an anti-virus application to identify the infected electronic file. Once the infected file has been identified, information identifying the infected electronic file is sent to a remote node, which queries a database storing a plurality commonly used electronic files to determine whether a clean version of the electronic file is stored at the database. If so, then all or part of the clean version of the infected electronic file is sent from the remote node, and used to replace all or part of the electronic file stored in the file system.

### FIELD OF THE INVENTION

The present invention relates to the field of disinfecting infected files in a file system.

### BACKGROUND TO THE INVENTION

Virus infection of computers and computer systems is a growing problem. Recently there have been many high profile examples where computer viruses have spread rapidly around the world causing many millions of pounds worth of damage in terms of lost data and lost working time.

Computer viruses are spread in many different ways. Early viruses were spread by the copying of infected files onto floppy disks, and the transfer of the file from the disk onto a previously uninfected computer. When the user tries to open the infected file, the virus is triggered and the computer infected. More recently, viruses have in addition been spread via the Internet, for example using e-mail. In the future it can be expected that viruses will be spread by the wireless transmission of data, for example by communications between mobile communication devices using a cellular telephone network.

Various anti-virus applications are available on the market today. These tend to work by maintaining a database of signatures or fingerprints for known viruses. With a “real time” scanning application, when a user tries to perform an operation on a file, e.g. open, save, or copy, the request is redirected to the anti-virus application. If the application has no existing record of the file, the file is scanned for known virus signatures. If a virus is identified in a file, the anti-virus application reports this to the user, for example by displaying a message in a pop-up window. The anti-virus application may then add the identity of the infected file to a register of infected files. Access to the file is denied. When a subsequent operation on the file is requested, the anti-virus application first checks the register to see if the file is infected. If it is infected, the access is denied. If the file is not infected, access is permitted (the anti-virus application may re-check the file if it detects that the file has changed since the previous check was performed).

Once a virus or malware has been detected, the user will typically want the anti-virus application to remove the virus (a process known as disinfection). There are several problems with existing methods of disinfection. Disinfection routines run script or code that attempts to restore the file, and are written for each malware “family” or even each malware variant. However, such routines may end up creating partially disinfected or broken files. Furthermore, even where a disinfection routine works, the digital signature of a disinfected file may be incorrect. This causes a problem for security applications (such as Digital Rights Management) that rely on checking the digital signature of the file.

Furthermore, where the virus modifies Operating System (OS) or application files, the infected files cannot be simply removed as this could cause the associated OS or application to work incorrectly. The virus may also integrate itself into the OS or application by changing registry and system settings, in addition to modifying files.

Some viruses may proxy the legitimate file by saving a copy of the original file and copying itself over it. When the file is required the infected file will be executed rather than the original. However, the infected file may also execute the original file in order to disguise the presence of the infected file in the system. The original file may be hidden or encrypted by the virus in order to make system recovery more difficult. Other viruses operate by infecting the original file such that the virus is activated once the infected file is executed.

In order to disinfect an infected file, an anti-virus application disinfection routine is developed that takes account of the method of infection. However, in some cases a virus might be detected for which a disinfection routine has not yet been developed. This can allow the virus to spread to other systems and cause further damage before it can be disinfected.

### SUMMARY OF THE INVENTION

It is an object of the invention to provide improved methods for disinfecting infected electronic files in a client system.

According to a first aspect of the invention, there is provided a method of disinfecting an infected electronic file in a file system. A file system is scanned using an anti-virus application to identify the infected electronic file. Once the infected file has been identified, information identifying the infected file is sent to a remote node. The remote node queries a database storing a plurality commonly used electronic files to determine whether a clean version of the electronic is stored at the database. If it is, then all or part of the clean version is sent from the remote node and all or part of the infected electronic file stored in the file system is replaced with all or part of the retrieved clean version of the electronic file. This procedure allows an infected file to be cleaned even when the malware infecting the file has not been identified, and does not require writing disinfection routines that may be ineffective at cleaning the file.

The remote node optionally receives a copy of the infected electronic file and compares the infected electronic file with the clean version of the electronic file stored at the database. This allows the remote node to determine portions of the electronic file required to replace portions of the infected electronic file.

Because the database stores a plurality commonly used electronic files, it allows a service provider to store in a database a large number of clean files belonging to commonly used software, and to provide portions of these clean files as necessary to users to disinfect infected electronic files.

The identifying information is optionally selected from any of a file name, a hash value derived using the electronic file, part of a hash value derived using the electronic file, a file path of the electronic file in the file system part of a file path of the electronic file, part of a file path of the electronic file, a Cyclic Redundancy Check block map of the electronic file and a Cyclic Redundancy Check value derived from the electronic file.

Alternatively, an update package is received from a remote node. The update package includes a clean version of at least part of an electronic file. If an infected electronic file is identified, the contents of the update package are installed such that the parts of the clean version of the electronic file replace the infected parts of the infected electronic file, thereby disinfecting it.

As an option, further data associated with the clean version of the electronic file is received, and at least a part of data associated with the infected electronic file stored in the file system is replaced with at least a part of the received further data. This ensures that any changes caused by the malware to data such as registry settings are also restored. The received further data optionally includes any of registry settings, system settings, file location, file size, file signature, file version, file author and file type.

It will be appreciated that system registry information may also be compromised if an electronic file is infected by malware. As an option, the backup database stores system registry information associated with the clean version of the files. Examples of system registry information include registry keys, value types and actual value. In this case, the method optionally further comprises sending replacement system registry information associated with the clean version of the electronic file from the remote node and, at the file system, updating system registry information associated with the electronic file stored at the file system with the replacement system registry information.

The file system described above is optionally stored at a client device.

According to a second aspect of the invention, there is provided a client device. The client device is provided with a memory for storing a plurality of electronic files and a processor for scanning the memory using an anti-virus application and identifying an infected electronic file stored at the memory. A transmitter is provided for sending identifying information relating to the infected electronic file to a remote node, and a receiver is provided for receiving from the remote node all or part of a clean version of the file obtained from a database storing a plurality commonly used electronic files. The processor is arranged to replace all or part of the infected electronic file stored in the memory with all or part of the retrieved clean version of the electronic file.

The receiver is optionally arranged to receive from a remote node an update package that includes a clean version of at least part of an electronic file. The memory is arranged to store a location of the update package, and the processor identifies an infected electronic file that has a corresponding electronic file stored in the update package. The processor is arranged to install the contents of the update package such that the parts of the clean version of the electronic file replaces the infected parts of the infected electronic file in the memory.

The memory is optionally arranged to store data associated with electronic files, and the receiver is arranged to receive further data associated with the clean version of the electronic file. In this case, the processor is arranged to replace at least a part of the data associated with the infected electronic file with at least a part of the received further data.

The invention can be applied to any type of client device, examples of which include a personal computer, a laptop computer, a mobile telephone and a Personal Digital Assistant.

According to a third aspect of the invention, there is provided a Server for use in a communications network. The Server is provided with a receiver for receiving from a client device identifying information of an infected electronic file, a communication device for communicating with a database to determine whether a clean version of the infected electronic file is stored at the database, and a transmitter for sending to the client device all or part of a copy of the clean version of the infected electronic file.

As an option, the Server is provided with a processor for comparing the infected electronic file with the clean version of the electronic file and identifying portions of the electronic file necessary to disinfect the infected electronic file.

According to a fourth aspect of the invention, there is provided a computer program, comprising computer readable code which, when run on a client device, causes the client device to behave as a client device as described in the second aspect of the invention.

According to a fifth aspect of the invention, there is provided a computer program product comprising a computer readable medium and a computer program according to the fourth aspect of the invention, wherein the computer program is stored on the computer readable medium.

According to a sixth aspect of the invention, there is provided a computer program, comprising computer readable code which, when run on a Server, causes the Server to behave as a Server as described in the third aspect of the invention.

According to a seventh aspect of the invention, there is provided a computer program product comprising a computer readable medium and a computer program according to the sixth aspect of the invention, wherein the computer program is stored on the computer readable medium.

### BRIEF DESCRIPTION OF THE DRAWINGS

FIG. 1 illustrates schematically in a block diagram a network architecture according to an embodiment of the invention;

FIG. 2 is a flow diagram illustrating a mechanism for disinfecting an infected electronic file stored in a file system according to first and third embodiments of the invention; and

FIG. 3 is a flow diagram illustrating a mechanism for disinfecting an infected electronic file stored in a file system according to a second embodiment of the invention.

FIG. 4 is a flow diagram illustrating a mechanism for disinfecting an infected electronic file stored in a file system according to a third embodiment of the invention.

### DETAILED DESCRIPTION OF CERTAIN EMBODIMENTS

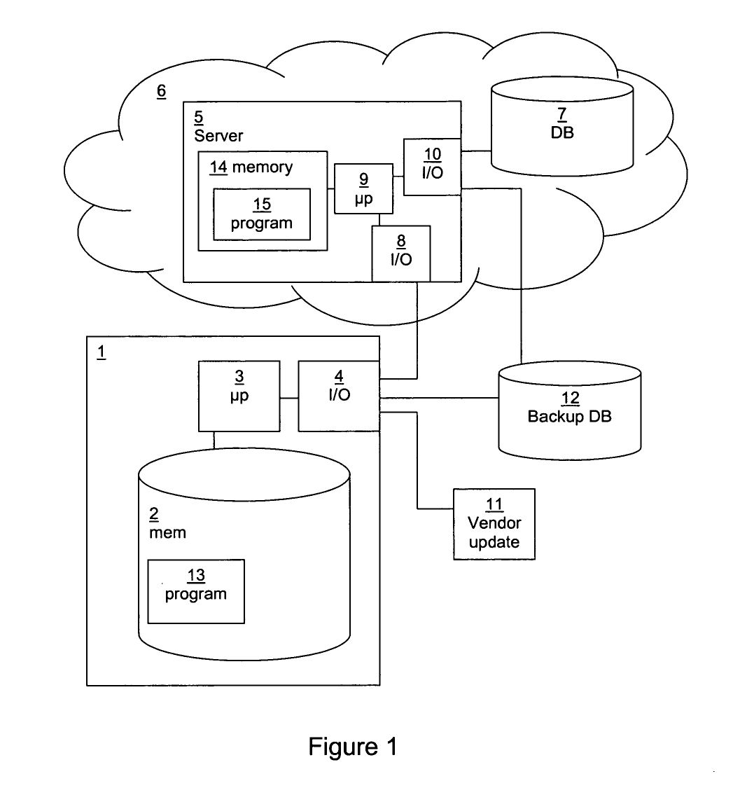

Referring to FIG. 1, there is illustrated a client device 1. The client device 1 may be any type of computer device, such as a desktop personal computer, a laptop computer, a mobile telephone, a Personal Digital Assistant (PDA) and so on. The client device has a memory 2 in which files are stored, in addition to computer programs such as the program required to run an anti-virus scan. The memory may be any writable medium in which files can be stored, such as a hard disk, a Random Access Memory, a flash disk and so on. Furthermore, whilst the memory 2 may be integral with the client device 1 it may also simply be connected to the client device 1. An example of a memory 2 connected to a client device is a hard disk connected via a USB connection to a desktop personal computer. A processor 3 is provided for running an anti-virus application and scanning the memory 2. In addition, ad I/O device 4 is provided for allowing the client device 1 to communicate with remote nodes.

When an anti-virus application is executed, the memory 2 is scanned for viruses. If a virus is found by any known method, such as looking for the signature of fingerprint of a virus, the I/O device 4 contacts a server 5 operated by a third party 6 such as the vendor of the anti-virus application. In addition to an identity of the file, other information could be sent, such as a hash value for the file, date of creation, date of modification, file location, associated registry settings and so on.

The server 5 contacts a database 7 which stores a large collection of clean files obtained from trusted vendors who provide operating systems, applications and so on. These clean files are copies of files provided by the software vendor to users. The database is necessarily very large, and as it has clean version of files associated with most major software, it is very likely to have a clean file corresponding to the infected file on the client device 1. For example, the database may include copies of Microsoft operating systems such as Windows Vista™, other operating systems, third-party applications such as Adobe Acrobat™, Microsoft Office, and so on. Of course, several version histories of each file may be stored, and versions of the files for use with different languages may also be stored.

The server 5 has an In/Out device 8 for communicating with the client device 1, a second In/Out 10 device for communicating with the database 7, and a processor 5. The server 5 performs a check to ascertain whether the database 7 has a clean file corresponding to the infected file in the memory 2. If so, then the server 5 compares the infected file with the clean file to identify parts of the clean file that must be sent to the client device 1 to restore the infected file to its original state. Synchronization data is sent to the client device 1, which uses the synchronization data to restore the infected file in the memory 2 to leave the user with an identical file to that stored in the database 7. In this way, the infected parts of a file are replaced with clean parts of the equivalent file stored in the remote database 7 in order to disinfect the file stored in the memory 2.

Of course, in addition to clean files, the database 7 may also contain other information such as registry and system settings, file size, file type, file location and so on, corresponding to the clean file that may need to be updated in the event that a file in the client device 1 memory 2 has been infected. Any of this information may be sent from the database 7 to the client device 1 if required.

In a second specific embodiment, an update package for software stored on the memory 2 is provided by a software vendor 11. The update package may be a vulnerability update, a software service pack, a vendor “hotfix”, a binary released for debugging purposes or any other type of released update. The update package includes clean versions of files. The antivirus application is provided with information as to how to install the update package. The update package may be stored locally on the client device 1, or may be stored remotely in a database.

If, during a subsequent scan, it is determined that a file is infected, then previously received update packages, either stored locally or at the remote database 7 are searched to determine whether an update package containing the file or system setting is available. If so, then the update package is installed into the memory 2 of the client device 1, replacing the infected file with the clean file. Alternatively, only selected portions of the update package need to be installed to replace specific portions of the infected file.

In a third specific embodiment of the invention, the user of the client device 1 has previously made use of a backup service in which copies are made of electronic files stored on the client device 1 and remotely stored in a back-up database 12 operated by a service provider. This back-up may be done periodically, after an initial install of a new operating system or application. The backup may include data files in addition to files relating to the user's operating system and applications.

If an infected file is identified on the client device 1, then the server 5 determines whether a clean version of the file is stored in the back-up database 12. If so, then the server 5 compares the infected files with the clean files identify parts of the clean file that must be sent to the client device 1 to restore the infected file to its original state. Synchronization data is sent to the client device 1, which uses the synchronization data to restore the infected file in the memory 2 to leave the user with an identical file to that stored in the database 7. In this way, the infected parts of a file are replaced with clean parts of the equivalent file stored in the backup database 12 in order to disinfect the file stored in the memory 2.

Finding a clean copy at the back-up database 12 can be performed using the name and path file of infected file. Typically, backup software maintains the location of the saved file and so the location of the infected file at the client device 1 can be used to retrieve the clean copy of the electronic file from the backup database 12.

However, if file path information is not available for the infected file, or a search is not possible, then during the original detection of the infected file, the anti-virus application can supply the full sized content hash of clean files. This is possible if the infected object belongs to a “well known” file, such as an operating system file. Therefore, once the anti-virus application has identified the infected file, it can identify it to the backup database 12 in order to obtain a clean replacement. The anti-virus can supply to the client device 1 one or more clean content hashes of that infected file. Multiple hashes may be supplied if there are several known clean instances of the same file.

As with the database 7 described in the first specific embodiment of the invention, the backup database 12 may also contain other information such as registry and system settings, file size, file type, file location and so on, corresponding to the clean file that may need to be updated in the event that a file in the client device 1 memory 2 has been infected.

Note that the memory 2 of the client device 1 is a computer readable medium in which a program 13 may be stored. When the program is executed by the processor 3, the client device 1 behaves in one of the ways described above. Similarly, the Server 5 may also be provided with a computer readable medium in the form of a memory 14 in which a program 15 is stored. When the program 15 is executed by the processor 9, the Server 5 behaves in one of the ways described above.

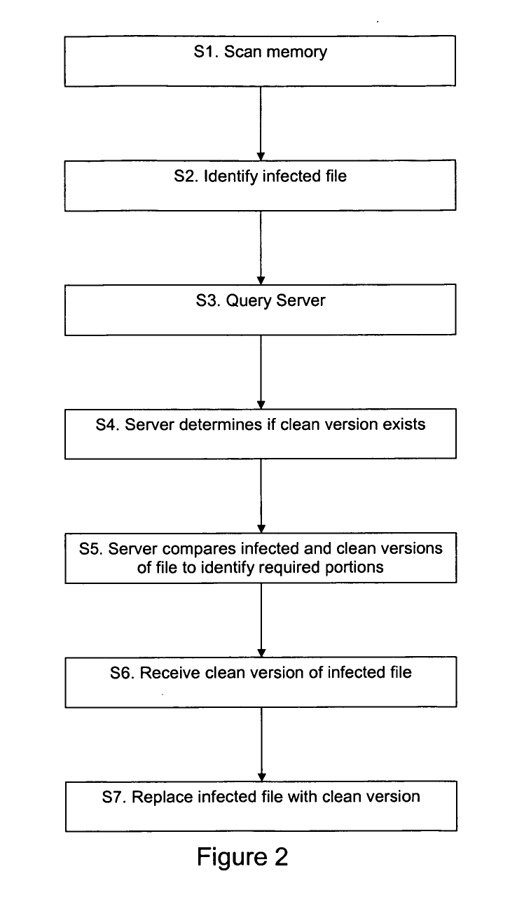

Turning now to FIG. 2, a flow diagram is shown illustrating steps of the first and third embodiments of the invention. The following numbering corresponds to the numbering of FIG. 2:

S1. The memory 2 of the client device 1 is scanned for viruses and other malware using an anti-virus application.

S2. An infected file is identified.

S3. According to the first specific and third embodiments, the server 5 is contacted and the infected file identified to the server 5. Other information may also be sent, such as the file location or registry settings associated with the file.

S4. The server 5 determines if a clean version of the infected file exists in the database 7 or the backup database 8.

S5. The server 5 may compare the infected file with the clean version to determine which portions to send.

S6. The server 5 then sends either a portion or all of the clean version of the file to the client device.

S7. The infected file is replaced by the clean version of the file, or least the infected portions of the infected file are replaced by their equivalent portions from the clean version of the file. Of course, other associated data such as registry and system settings may also be replaced

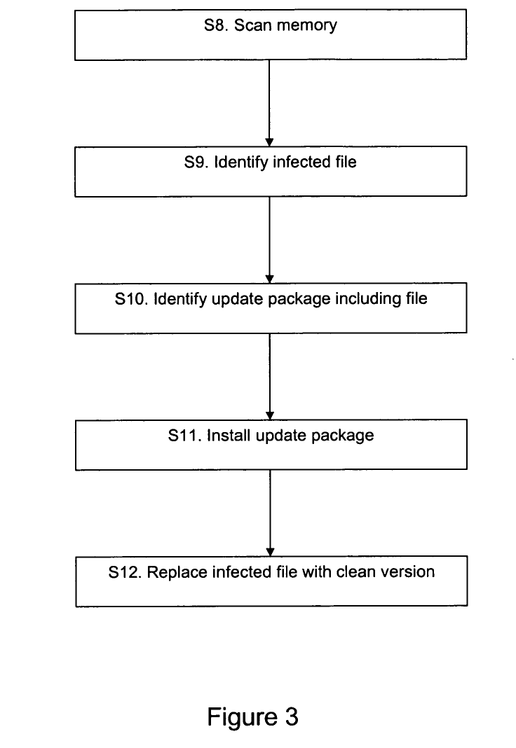

FIG. 3 is a flow diagram illustrating the steps of the second embodiment of the invention, with the following numbering corresponding to the numbering of FIG. 3:

S8. The memory 2 of the client device 1 is scanned for viruses and other malware using an anti-virus application.

S9. An infected file is identified.

S10. A vendor-supplied update package is identified that includes a clean version of the infected file;

S11. The update package is installed, or at least portions of the update package that include the clean version of the infected file;

S12. The infected file is replaced by the clean version of the file, or least the infected portions of the infected file are replaced by their equivalent portions from the clean version of the file. Of course, other associated data such as registry and system settings may also be replaced.

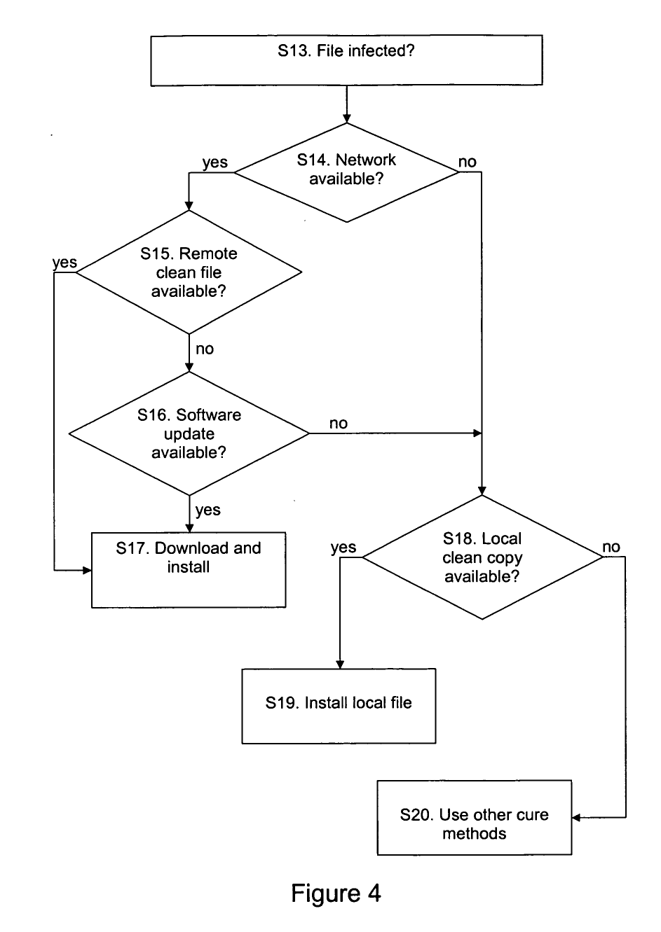

It will be appreciated that combinations of any of the above described embodiments may be implemented at a client device 1. The example illustrated in FIG. 4 assumes that all three embodiments are implemented at the client device 1. The following numbering corresponds to the numbering in FIG. 4:

S13. An infected file is identified in the file system of the client device 1.

S14. A check is made to determine if the client device has access to remote nodes. It is possible that malware may block access to a sever storing clean versions of files, or that the network is generally not available. If the network is available, then move to step S15, if not then move to step S18.

S15. If a connection to the server 5 is available, then a determination is made as to whether the clean version of the file is available, and the process continues at step S17.

S16. If a clean version of the file is not available at the server 5, then a determination is made whether a software update is available. If not, then move to step S18.

S17. The clean version of the file (or parts of the clean version of the file) are downloaded and installed to replace the infected parts of the electronic file stored in the file system, and the process ends.

S18. If a connection is not available, or clean versions of the file cannot be found, then a determination is made to check whether a clean version of the file is available locally, for example in backup copies of files created by a service pack installation. If not, then move to step S19.

S19. The locally found clean version of the file is installed to replace the infected portions of the electronic file stored at the file system, thereby disinfecting it, and the process ends.

S20. If clean versions of the file are not available remotely or locally, then other disinfection methods should be used, such as running a script.

The invention reduces the need for running a script to disinfecting an infected file, as the infected portions of the file are simply replaced. This means that problems associated with scripts that only partially work are overcome. Furthermore, a script for repairing an infected file need not be written, as it is simply enough to identify that a file is infected. The file can be disinfected immediately, thereby overcoming problems associated with waiting for a suitable script to be provided by the ant-virus application provider.

It will be appreciated by the person of skill in the art that various modifications may be made to the above described embodiment without departing from the scope of the present invention.

1. A method of disinfecting an infected electronic file in a file system, the method comprising:
scanning the file system using an anti-virus application to identify the infected electronic file;
sending identifying information of the infected electronic file to a remote node;
at the remote node, querying a database storing a plurality commonly used electronic files to determine whether a clean version of the electronic file is stored at the database;
in the event that the clean version of the electronic file is stored at the database, sending all or part of the clean version of the electronic file from the remote node; and
replacing all or part of the infected electronic file stored in the file system with all or part of the retrieved clean version of the electronic file.

2. The method according to claim 1, further comprising:
at the remote node, receiving a copy of the infected electronic file;
comparing the infected electronic file with the clean version of the electronic file stored at the database to determine portions of the electronic file required to replace portions of the infected electronic file.

3. The method according to claim 1, wherein the identifying information is selected from one of a file name, a hash value derived using the electronic file, part of a hash value derived using the electronic file, a file path of the electronic file in the file system, part of a file path of the electronic file, a Cyclic Redundancy Check block map of the electronic file and a Cyclic Redundancy Check value derived from the electronic file.

4. The method according to claim 1, further comprising:
receiving from a remote node an update package, the update package including a clean version of at least part of an electronic file;
after identifying the infected electronic file stored in the file system, installing the contents of the update package such that the clean version of the at least part of the electronic file replaces infected parts of the electronic file.

5. The method according to claim 1, further comprising receiving further data associated with the clean version of the electronic file, and replacing at least a part of data associated with the infected electronic file with at least a part of the received further data.

6. The method according to claim 1, further comprising receiving further data associated with the clean version of the electronic file, and replacing at least a part of data associated with the infected electronic file with at least a part of the received further data, wherein the received further data includes any of registry settings, system settings, file location, file size, file signature, file version, file author and file type.

7. The method according to claim 1, further comprising:
obtaining from the database replacement system registry information associated with the clean version of the electronic file;
sending the replacement system registry information from the remote node and,
at the file system, updating system registry information associated with the electronic file stored at the file system with the replacement system registry information.

8. The method according to claim 1, wherein the file system is stored at a client device.

9. A client device, the client device comprising:
a memory for storing a plurality of electronic files;
a processor for scanning the memory using an anti-virus application and identifying an infected electronic file stored at the memory;
a transmitter for, after identifying the infected electronic file, sending an identity of the infected electronic file to a remote node;
a receiver for receiving from the remote node all or part of a clean version of the electronic file obtained from a database storing a plurality commonly used electronic files;
wherein the processor is arranged to replace all or part of the infected electronic file stored in the memory with all or part of the received clean version of the electronic file.

10. The client device according to claim 9, wherein the receiver is configured to receive from the remote node an update package, the update package including the clean version of at least part of an electronic file, and the memory is arranged to store a location of the update package, wherein the processor is arranged to, after identifying the infected electronic file, install the contents of the update package such that the parts of the clean version of the electronic file replaces the parts of the infected electronic file in the memory.

11. The client device according to claim 9, wherein the memory is arranged to store data associated with electronic files, the receiver is arranged to receive further data associated with the clean version of the electronic file, and the processor is arranged to replace at least a part of the data associated with the infected electronic file with at least a part of the received further data.

12. The client device according to claim 9, wherein the client device is selected from one of a personal computer, a laptop computer, a mobile telephone and a Personal Digital Assistant.

13. A Server for use in a communications network, the Server comprising:
a receiver for receiving from a client device identifying information of an infected electronic file;
a communication device for communicating with a database storing a plurality commonly used electronic files to determine whether a clean version of the infected electronic file is stored at the database;
a transmitter for sending to the client device all or part of a copy of the clean version of the infected electronic file.

14. The Server according to claim 13, further comprising:
a processor for comparing the infected electronic file with the clean version of the electronic file and identifying portions of the electronic file necessary to disinfect the infected electronic file.

15. A computer program, comprising computer readable code which, when run on a client device, causes the client device to behave as a client device as claimed in claim 9.

16. A computer program product comprising a computer readable medium and a computer program according to claim 15, wherein the computer program is stored on the computer readable medium.

17. A computer program, comprising computer readable code which, when run on a Server, causes the Server to behave as a Server as claimed in claim 13.

18. A computer program product comprising a computer readable medium and a computer program according to claim 17, wherein the computer program is stored on the computer readable medium.
